(19) United States
(12) Patent Application Publication
(10) Pub. No.: US 2025/0079765 A1
(43) Pub. Date: Mar. 6, 2025

(54) MEMORY SOCKET WITH A PUSH EJECT LOCKING MECHANISM

(71) Applicant: DELL PRODUCTS L.P., Round Rock, TX (US)

(72) Inventors: Chun-Ting Lu, New Taipei City (TW); JerYo Lee, Taipei (TW); Cheng-Hsiang Chuang, New Taipei City (TW); Yo-Huang Chang, Taipei City (TW)

(21) Appl. No.: 18/457,901

(22) Filed: Aug. 29, 2023

(51) Int. Cl. H01R 13/629

(52) U.S. Cl. CPC H01R 13/62983; H01R 12/72

(57) ABSTRACT

A memory socket includes a frame having a base portion and a side portion, and a push-eject locking mechanism in physical communication with the base portion and with the side portion. The push-eject locking mechanism to transition between an unlocked position and a locked position. The push-eject locking mechanism includes an eject bar component and a lever component. The weight of the eject bar component biases the push-eject locking mechanism towards the unlocked position. Based on a force being exerted on the lever component, the lever component pivots and transition the push-eject locking mechanism from the unlocked position to the locked position.

### FIELD OF THE DISCLOSURE

The present disclosure generally relates to information handling systems, and more particularly relates to a memory socket with a push eject locking mechanism.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A memory socket includes a frame having a base portion and a side portion, and a push-eject locking mechanism in physical communication with the base portion and with the side portion. The push-eject locking mechanism to transition between an unlocked position and a locked position. The push-eject locking mechanism includes an eject bar component and a lever component. The weight of the eject bar component may bias the push-eject locking mechanism towards the unlocked position. Based on a force being exerted on the lever component, the lever component may pivot and transition the push-eject locking mechanism from the unlocked position to the locked position.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of an information handling system according to at least one embodiment of the present disclosure;

FIG. 2 is a side view of a memory socket according to at least one embodiment of the present disclosure;

FIG. 3 is a perspective view of one side of a memory socket according to at least one embodiment of the present disclosure;

FIG. 4 is a perspective view of an eject bar component according to at least one embodiment of the present disclosure;

FIG. 5 is a perspective view of a clip component according to at least one embodiment of the present disclosure;

FIG. 6 is a perspective view of a lever component according to at least one embodiment of the present disclosure;

FIGS. 7-9 are a cross-sectional views via of a push-eject locking mechanism, a memory socket, and a memory card according to at least one embodiment of the present disclosure; and

FIG. 10 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

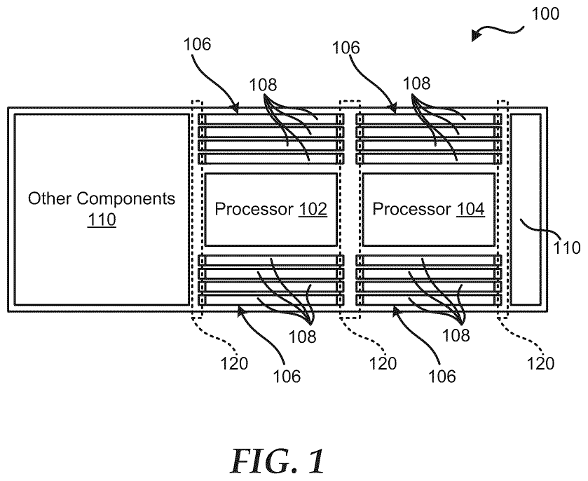

FIG. 1 illustrates a portion of an information handling system 100 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Information handling system 100 includes a processors 102 and 104, multiple memory slots/sockets 106, multiple memory cards 108, and other components 110. In an example, information handling system 100 may be a component node tray within a server rack or the like. Memory cards 108 may be any suitable type of memory cards, such as double data rate (DDR) memory cards. Processors 102 and 104 may be in communication with memory cards 108, a subset of the memory cards, or the like. In an example, each memory card 108 may be inserted within a different one of memory sockets 106. Each memory card 108 may be held in place by locking mechanisms with one of the locking mechanisms located at each end of the corresponding memory socket. Information handling system 100 may include additional components without varying from the scope of this disclosure.

In an example, the locking mechanisms for a particular memory socket 106 may transition between a locked position and an unlocked position. While the locking mechanisms are in the locked position, memory card 108 may be securely held within memory socket 106. While the locking mechanisms are in the unlocked position, memory card 108 may be inserted or removed from memory socket 106. In certain examples, spacing may be limited within information handling system 100. For example, information handling system 100 may have a limited amount of space 120 adjacent to memory sockets 106 that the locking mechanisms may occupy while in the unlocked position. In certain examples, a reduction in size for spaces 120 may increase an amount of space or area within information handling system 100 for other components.

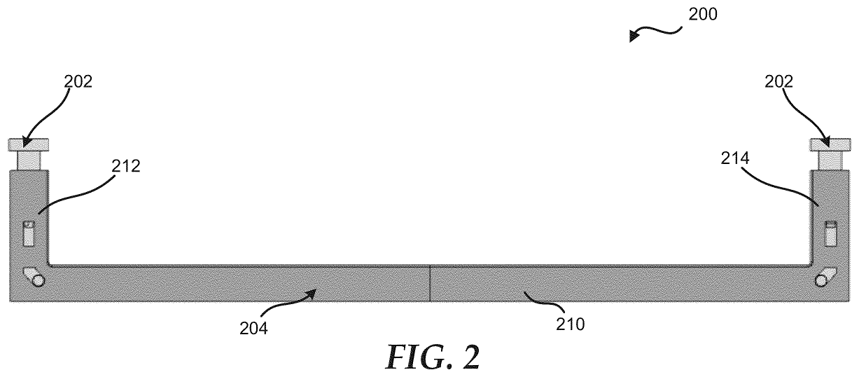

In an example, if the locking mechanisms extend beyond space 120, the locking mechanisms may come in physical contact with other components 110 or other memory slots 106. This physical contact may cause damage to other components 110 or may not allow the locking mechanisms to fully transition to the unlocked position. Information handling system 100 includes a push-eject locking mechanism, such as push-eject locking mechanism described below with respect to FIGS. 2-9.

FIG. 2 illustrates a memory socket 200 according to at least one embodiment of the present disclosure. Memory socket 200 may be substantially similar to memory slots/sockets 106 of FIG. 1. Memory socket 200 includes push-eject locking mechanisms 202, and a frame 204. Frame 204 includes a base 210 and side portions 212 and 214. Memory socket 200 may include additional components or portions without varying from the scope of this disclosure.

In an example, side portions 212 and 214 may be located on opposite/distal ends of base 210. Side portions 212 and 214 may extend perpendicularly away from base 210. In certain examples, one of push-eject locking mechanisms 202 may be located within side portion 212 and the other push-eject locking mechanism may be located within side portion 214. In an example, side portions 212 and 214 may be hollow to enable the corresponding push-eject locking mechanisms 202 to be located within frame 204 of memory socket 200. Push-eject locking mechanisms 202 may transition between a locked position and an unlocked position. In an example, the weight of push-eject locking mechanisms 202 may bias the push-eject locking mechanisms toward the unlocked position. As a memory card is inserted within memory socket 200, push-eject locking mechanisms 202 may transition from the unlocked position to the locked position. While push-eject locking mechanisms 202 are in the locked position, the push-eject locking mechanisms may securely hold the memory card within memory socket 200.

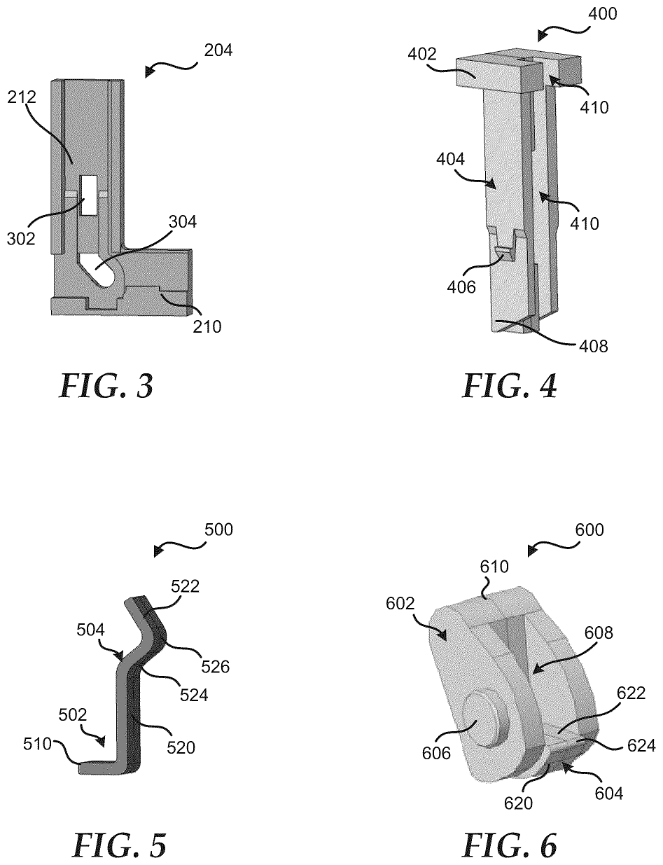

FIG. 3 illustrates one side of frame 204 according to at least one embodiment of the present disclosure. Frame 204 includes a catch notch 302 and a slide notch 304. In an example, catch notch 302 is located within side portion 212 of frame 204. Slide notch 304 is located within an intersection of base 210 and side portion 212 of frame 204. In certain examples, catch notch 302 may interface with an eject bar component, such as eject bar component 400 of FIG. 4, of one of push-eject locking mechanisms 202. In an example, slide notch 304 may interface with a lever, such as lever 600 of FIG. 6, of one of push-eject locking mechanisms 202. While FIG. 3 illustrates only one side of frame 204 of memory socket 200, the other side of memory socket 200 may be substantially similar to the side described herein and both sides will be combined together to form a complete memory slot such memory socket 106 of FIG. 1.

FIG. 4 illustrates eject bar component 400 of a push-eject locking mechanism, such as push-eject locking mechanism 202 of FIG. 2, according to at least one embodiment of the present disclosure. Eject bar component 400 includes a push top portion 402, a main portion 404, a hook components 406, a base portion 408, and a channel 410. Hook component 406 includes a slip potion 420 and a catch portion 422. Eject bar component 400 may include additional components without varying from the scope of this disclosure. For example, while only a single hook component 406 is shown in FIG. 4, an additional hook component may be located on an opposite surface of main portion 404. In an example, push top portion 402 may extend beyond edge surfaces of main portion 404. In this example, push top portion 402 may provide additional surface area for an individual to exert a force on eject bar component 400, which may cause the push-eject locking mechanism to transition from the locked position to the unlocked position. In certain examples, the weight of eject bar component 400 may cause push-eject locking mechanism 202 of FIG. 2 to be biased toward the unlocked position.

In an example, a memory card, such as memory card 108 of FIG. 1, may slide within channel 410 as the memory card is inserted into memory slot or removed from the memory slot. In certain examples, hook component 406 may be inserted within a catch notch of a frame, such as catch notch 302 of frame 204 in FIG. 3. Hook component 406 may hold eject bar component 400 within the memory slot. For example, slip portion 420 may slide beyond an upper edge of the catch notch such that hook component 406 may be inserted within the catch notch. When hook component 406 is located within the catch notch, catch portion 422 of the hook component may hold the hook component within the catch notch.

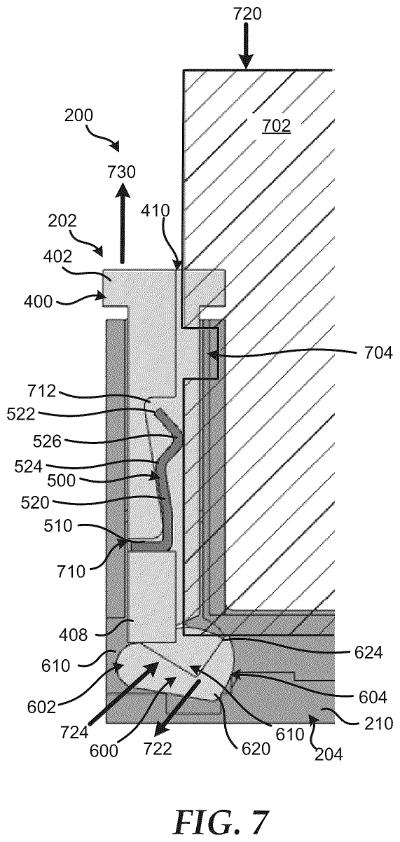

In certain examples, base portion 408 may be placed in physical communication with a lever component of a push-eject locking mechanism, such as lever component 600 of push-eject locking mechanism 202. In an example, a force exerted down on push top portion 402 of eject bar component 400 may be transferred from base portion 408 to the lever component, which may cause the lever component to pivot as will be described below with respect to FIGS. 7-9.

FIG. 5 illustrates a clip component 500 of a push-eject locking mechanism, such as push-eject locking mechanism 202 of FIG. 2, according to at least one embodiment of the present disclosure. Clip component 500 includes an insert portion 502 and a bent portion 504. Insert portion 502 includes a straight portion 510, and bent portion 504 includes a support portion 520, a slant portion 522, and curve portions 524 and 526. Clip component 500 may include additional components without varying from the scope of this disclosure.

In an example, clip component 500 may be utilized to hold push-eject locking mechanism 202 of FIG. 2 in the locked position. For example, bent portion 502 may snap fit within a notch of a memory card to both hold push-eject locking mechanism 202 of FIG. 2 in the locked position and secure the memory card within a memory socket as will be described with respect to FIGS. 7-9 below. In an example, straight portion 510 of insert portion 502 may be utilized to securely hold clip component 500 within an eject bar component, such as eject bar component 400 of FIG. 4. In certain examples, curve portions 524 and 426 of bent portion 504 may provide different forces to hold push-eject locking mechanism 202 of FIG. 2 in wither the locked position or the unlocked position as will be described with respect to FIGS. 7-9 below.

FIG. 6 illustrates a lever component 600 of a push-eject locking mechanism, such as push-eject locking mechanism 202 of FIG. 2, according to at least one embodiment of the present disclosure. Lever component 600 includes a main portion 602, slope portion 604, tabs 606, and a channel 608. While only a single tab 606 is illustrated in FIG. 6, lever component 600 may include another tab on an opposite surface of main portion 602 as the illustrated tab. Main portion 602 includes a curved portion 610. Slope portion 604 includes a base portion 620, a support portion 622, and an intersection 624. Lever component 600 may include additional components without varying from the scope of this disclosure.

In an example, lever component 600 may be in physical communication with an eject bar component of a push-eject locking mechanism, such as eject bar component 400 of FIG. 4. In certain examples, tabs 606 may be any suitable shape to enable lever component 600 from pivot when a force is exerted downward on curved portion 610. For example, each of tabs 606 may be a cylinder shape. Support portion 622 may be in physical communication with a memory card while push-eject locking mechanism 202 of FIG. 2 is in the locked position. In an example, intersection 624 may be in physical communication with a memory card while push-eject locking mechanism 202 of FIG. 2 transitions from the locked position to the unlocked position.

FIGS. 7-9 illustrate a cross-section of a memory card 702, push-eject locking mechanism 202, frame 204 of memory socket 200, clip component 500, and lever component 600 according to at least one embodiment of the present disclosure. Memory card 702 may be substantially similar to memory cards 108 of FIG. 1. Eject bar component 400 of push-eject locking mechanism 202 includes a slot 710 and a cavity 712. Straight portion 510 of clip component 500 may be inserted within slot 710 of eject bar component 400. In an example, straight portion 510 may securely hold clip component 500 within eject bar component 400. Lever component 600 may be located within base portion 210 of frame 204. In certain examples, memory card 702 may be inserted within frame 204 of memory socket 200, and within channel 410 of eject bar component 400.

Referring now to FIG. 7, a force may be exerted on memory card 702 in the direction of arrow 720. In response to the force, memory card 702 may slide within channel 410 and the memory card may be placed in physical communication with curve portion 526 of clip component 500 and with intersection 624 of lever component 600. Memory card 702 may exert a force on clip component 500, and this force may push support portion 520 and curve portion 524 in physical communication with cavity 712 of eject bar component 400.

In an example, the force on memory card 702 in the direction of arrow 720 may be transferred to lever component 600 via intersection 624 of slope portion 604. This force may cause lever component 600 to pivot around tabs 606 of FIG. 6. For example, slope portion 604 may pivot/move in the direction of arrow 722 and main portion 602 may pivot/move in the substantially opposite direction of arrow 724. As slop portion 604 pivots/moves in the direction of arrow 722, base portion 620 may be in physical communication with and slide along frame 204.

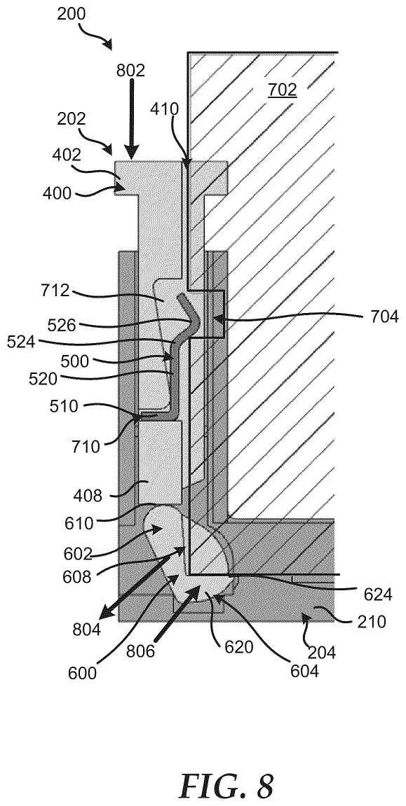

Based on the movement of main portion 602 in the direction of arrow 724, a force may be exerted on base portion 408 of eject bar component 400 by curve portion 610 of lever component 600. This force may be transferred from base portion 408, through main portion 404 and push top portion 402 in the direction of arrow 730. Push-eject locking mechanism 202 may move in the direction of arrow 730 based on memory card 702 being inserted within frame 204 of memory socket 200. In an example, as memory card 702 is inserted further within frame 204 of memory socket 200, push-eject locking mechanism 202 may transition from the unlocked position illustrated in FIG. 7 to the locked position illustrated in FIG. 8.

Referring now to FIG. 8, push-eject locking mechanism 202 is illustrated in the locked position. While in the locked position, curve portion 526 of clip component 500 may snap fit within notch 704 of memory card 702. Clip component 500 may securely hold push-eject locking mechanism 202 in the locked position and hold memory card 702 within memory socket 200. When push-eject locking mechanism 202 is in the locked position, a section of support portion 520 and curve portion 526 of clip component 500 may be no longer in physical communication with cavity 712 of eject bar component 400. In an example, while push-eject locking mechanism 202 is in the locked position, support portion 622 of lever component 600 may be in physical communication with a bottom surface of memory card 702.

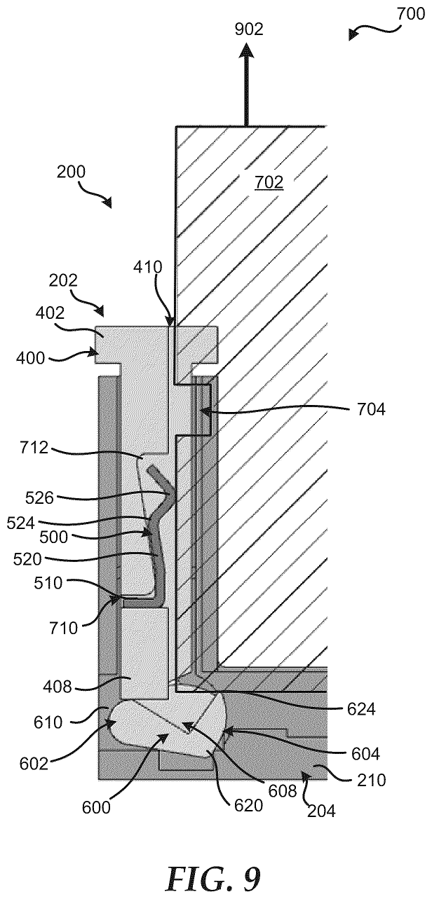

In an example, a force may be exerted in the direction of arrow 802 on push top portion 402 of eject bar component 400. In certain examples, the force in the direction of arrow 802 may be larger than a force of clip component 500 being held within notch 704 of memory card 702. In response to the force in the direction of arrow 802 being a larger force, curve portion 526 of clip component 500 may slip beyond notch 704 as illustrated in FIG. 9. Additionally, the force on push-eject locking mechanism 202 may be transferred through eject bar component 400 to base portion 408, which in turn may provide a substantially similar force on lever component 600 via the physical communication between the base portion 408 and curve portion 610 of the lever component. This force may cause lever component 600 to pivot around tabs 606 of FIG. 6. For example, main portion 602 may pivot/move in the direction of arrow 804 and slope portion 604 may pivot/move in the substantially opposite direction of arrow 806. In certain examples, the movement of lever component 600 may exert a force on memory card 702 via support portion 622 to move the memory card in the direction of arrow 902 illustrated in FIG. 9.

Referring now to FIG. 9, push-eject locking mechanism 202 is in the unlocked position. While push-eject locking mechanism 202 is in the unlocked position, curve portion 526 of clip component 500 may no longer be within notch 704 of memory card 702. Based on curved portion 526 no longer being with notch 704, memory card 702 may be moved within channel 410 in the direction of arrow 902. The movement within channel 410 may cause memory card 702 to be removed from eject bar component 400 of push-eject locking mechanism 202 and from frame 204 of memory socket 200.

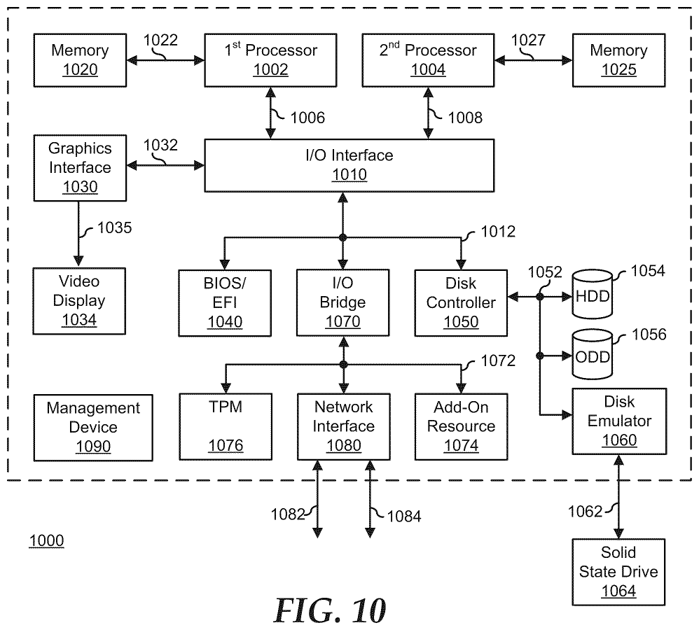

FIG. 10 shows a generalized embodiment of an information handling system 1000 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 1000 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 1000 can include processing resources for executing machine-executable code, such as a central processing unit (CPU), a programmable logic array (PLA), an embedded device such as a System-on-a-Chip (SoC), or other control logic hardware. Information handling system 1000 can also include one or more computer-readable medium for storing machine-executable code, such as software or data. Additional components of information handling system 1000 can include one or more storage devices that can store machine-executable code, one or more communications ports for communicating with external devices, and various input and output (I/O) devices, such as a keyboard, a mouse, and a video display. Information handling system 1000 can also include one or more buses operable to transmit information between the various hardware components.

Information handling system 1000 can include devices or modules that embody one or more of the devices or modules described below and operates to perform one or more of the methods described below. Information handling system 1000 includes a processors 1002 and 1004, an input/output (I/O) interface 1010, memories 1020 and 1025, a graphics interface 1030, a basic input and output system/universal extensible firmware interface (BIOS/UEFI) module 1040, a disk controller 1050, a hard disk drive (HDD) 1054, an optical disk drive (ODD) 1056, a disk emulator 1060 connected to an external solid state drive (SSD) 1062, an I/O bridge 1070, one or more add-on resources 1074, a trusted platform module (TPM) 1076, a network interface 1080, a management device 1090, and a power supply 1095. Processors 1002 and 1004, I/O interface 1010, memory 1020, graphics interface 1030, BIOS/UEFI module 1040, disk controller 1050, HDD 1054, ODD 1056, disk emulator 1060, SSD 1062, I/O bridge 1070, add-on resources 1074, TPM 1076, and network interface 1080 operate together to provide a host environment of information handling system 1000 that operates to provide the data processing functionality of the information handling system. The host environment operates to execute machine-executable code, including platform BIOS/UEFI code, device firmware, operating system code, applications, programs, and the like, to perform the data processing tasks associated with information handling system 1000.

In the host environment, processor 1002 is connected to I/O interface 1010 via processor interface 1006, and processor 1004 is connected to the I/O interface via processor interface 1008. Memory 1020 is connected to processor 1002 via a memory interface 1022. Memory 1025 is connected to processor 1004 via a memory interface 1027. Graphics interface 1030 is connected to I/O interface 1010 via a graphics interface 1032 and provides a video display output 1036 to a video display 1034. In a particular embodiment, information handling system 1000 includes separate memories that are dedicated to each of processors 1002 and 1004 via separate memory interfaces. An example of memories 1020 and 1030 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 1040, disk controller 1050, and I/O bridge 1070 are connected to I/O interface 1010 via an I/O channel 1012. An example of I/O channel 1012 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 1010 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 1040 includes BIOS/UEFI code operable to detect resources within information handling system 1000, to provide drivers for the resources, initialize the resources, and access the resources. BIOS/UEFI module 1040 includes code that operates to detect resources within information handling system 1000, to provide drivers for the resources, to initialize the resources, and to access the resources.

Disk controller 1050 includes a disk interface 1052 that connects the disk controller to HDD 1054, to ODD 1056, and to disk emulator 1060. An example of disk interface 1052 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 1060 permits SSD 1064 to be connected to information handling system 1000 via an external interface 1062. An example of external interface 1062 includes a USB interface, an IEEE 4394 (Firewire) interface, a proprietary interface, or a combination thereof. Alternatively, solid-state drive 1064 can be disposed within information handling system 1000.

I/O bridge 1070 includes a peripheral interface 1072 that connects the I/O bridge to add-on resource 1074, to TPM 1076, and to network interface 1080. Peripheral interface 1072 can be the same type of interface as I/O channel 1012 or can be a different type of interface. As such, I/O bridge 1070 extends the capacity of I/O channel 1012 when peripheral interface 1072 and the I/O channel are of the same type, and the I/O bridge translates information from a format suitable to the I/O channel to a format suitable to the peripheral channel 1072 when they are of a different type. Add-on resource 1074 can include a data storage system, an additional graphics interface, a network interface card (NIC), a sound/video processing card, another add-on resource, or a combination thereof. Add-on resource 1074 can be on a main circuit board, on separate circuit board or add-in card disposed within information handling system 1000, a device that is external to the information handling system, or a combination thereof.

Network interface 1080 represents a NIC disposed within information handling system 1000, on a main circuit board of the information handling system, integrated onto another component such as I/O interface 1010, in another suitable location, or a combination thereof. Network interface device 1080 includes network channels 1082 and 1084 that provide interfaces to devices that are external to information handling system 1000. In a particular embodiment, network channels 1082 and 1084 are of a different type than peripheral channel 1072 and network interface 1080 translates information from a format suitable to the peripheral channel to a format suitable to external devices. An example of network channels 1082 and 1084 includes InfiniBand channels, Fibre Channel channels, Gigabit Ethernet channels, proprietary channel architectures, or a combination thereof. Network channels 1082 and 1084 can be connected to external network resources (not illustrated). The network resource can include another information handling system, a data storage system, another network, a grid management system, another suitable resource, or a combination thereof.

Management device 1090 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 1000. In particular, management device 1090 is connected to various components of the host environment via various internal communication interfaces, such as a Low Pin Count (LPC) interface, an Inter-Integrated-Circuit (I²C) interface, a PCIe interface, or the like, to provide an out-of-band (OOB) mechanism to retrieve information related to the operation of the host environment, to provide BIOS/UEFI or system firmware updates, to manage non-processing components of information handling system 1000, such as system cooling fans and power supplies. Management device 1090 can include a network connection to an external management system, and the management device can communicate with the management system to report status information for information handling system 1000, to receive BIOS/UEFI or system firmware updates, or to perform other task for managing and controlling the operation of information handling system 1000.

Management device 1090 can operate off of a separate power plane from the components of the host environment so that the management device receives power to manage information handling system 1000 when the information handling system is otherwise shut down. An example of management device 1090 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 1090 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A memory socket comprising:
a frame having a base portion and a side portion; and
a push-eject locking mechanism in physical communication with the base portion and with the side portion, the push-eject locking mechanism to transition between an unlocked position and a locked position, the push-eject locking mechanism including:
an eject bar component, wherein a weight of the eject bar component biases the push-eject locking mechanism towards the unlocked position; and
a lever component in physical communication with the eject bar component, wherein based on a force exerted on the lever component the lever component pivots in a first direction and transitions the push-eject locking mechanism from the unlocked position to the locked position.

2. The memory socket of claim 1, wherein the push-eject locking mechanism further comprises: a clip component in physical communication with the eject bar component, the clip component to exert a first force to hold the push-eject locking mechanism in the locked position.

3. The memory socket of claim 2, wherein based on a second force exerted on the eject bar component being greater than the first force, the push-eject locking mechanism to transition from the locked position to the unlocked position.

4. The memory socket of claim 3, wherein the second force is transferred from the eject bar component to the lever component, and based on the second force, the lever component to pivot in a second direction.

5. The memory socket of claim 2, wherein the clip component includes a straight portion to securely hold the clip component in physical communication with the eject bar component.

6. The memory socket of claim 1, wherein the base portion includes a slide notch in physical communication with a tab of the lever component, the tab to move within the slide notch as the lever component pivots.

7. The memory socket of claim 1, wherein the lever component is located within the base portion of the frame.

8. The memory socket of claim 1, wherein side portion extend perpendicular from an edge of the base portion.

9. An information handling system comprising:
a memory card; and
a memory socket including:
a frame having a base portion and a side portion; and
a push-eject locking mechanism in physical communication with the base portion and with the side portion, the push-eject locking mechanism to transition between an unlocked position and a locked position, the push-eject locking mechanism including:
an eject bar component, wherein a weight of the eject bar component biases the push-eject locking mechanism towards the unlocked position; and
a lever component in physical communication with the eject bar component, based on a force being exerted on the lever component by the memory card, the lever component to pivot in a first direction and to transition the push-eject locking mechanism from the unlocked position to the locked position.

10. The information handling system of claim 9, wherein the push-eject locking mechanism further comprises: a clip component in physical communication with the eject bar component, the clip component to exert a first force to hold the push-eject locking mechanism in the locked position.

11. The information handling system of claim 10, wherein based on a second force exerted on the eject bar component being greater than the first force, the push-eject locking mechanism to transition from the locked position to the unlocked position.

12. The information handling system of claim 11, wherein the second force is transferred from the eject bar component to the lever component, and based on the second force, the lever component to pivot in a second direction.

13. The information handling system of claim 10, wherein the clip component includes a straight portion to securely hold the clip component in physical communication with the eject bar component.

14. The information handling system of claim 10, wherein the memory card includes a notch, wherein a curve portion of the clip component snap fits within the notch when the push-eject locking mechanism is in the locked position.

15. The information handling system of claim 9, wherein the base portion includes a slide notch in physical communication with a tab of the lever component, the tab to move within the slide notch as the lever component pivots.

16. The information handling system of claim 9, wherein the lever component is located within the base portion of the frame.

17. The information handling system of claim 9, wherein side portion extend perpendicular from an edge of the base portion.

18. An information handling system comprising:
a memory card including a notch; and
a memory socket including:
a frame having a base portion and a side portion; and
a push-eject locking mechanism in physical communication with the base portion and with the side portion, the push-eject locking mechanism to transition between an unlocked position and a locked position, the push-eject locking mechanism having:
an eject bar component including a channel, wherein a weight of the eject bar component biases the push-eject locking mechanism towards the unlocked position, wherein the memory card slides within the channel as the memory card is inserted into the memory socket; and
a lever component in physical communication with the eject bar component, wherein the lever component pivots in a first direction and transitions the push-eject locking mechanism from the unlocked position to the locked position based on a force exerted on the lever component by the memory card.

19. The information handling system of claim 18, wherein the push-eject locking mechanism further comprises: a clip component in physical communication with the eject bar component, the clip component to exert a first force to hold the push-eject locking mechanism in the locked position.

20. The information handling system of claim 19, wherein based on a second force exerted on the eject bar component being greater than the first force, the push-eject locking mechanism to transition from the locked position to the unlocked position.
